(19) United States
(12) Patent Application Publication
(10) Pub. No.: US 2011/0096314 A1
(43) Pub. Date: Apr. 28, 2011

(54) OPTICAL DEVICE, EXPOSURE APPARATUS USING SAME, AND DEVICE MANUFACTURING METHOD

(75) Inventor: Takeshi Sato, Utsunomiya-shi (JP)

(73) Assignee: CANON KABUSHIKI KAISHA, Tokyo (JP)

(21) Appl. No.: 12/902,654

(22) Filed: Oct. 12, 2010

(30) Foreign Application Priority Data
Oct. 26, 2009 (JP) 2009-245290

(51) Int. Cl. G03B 27/54; G03B 27/32; G02B 7/02

(52) U.S. Cl. 355/67; 355/77; 359/819

(57) ABSTRACT

The optical device of the present invention includes an optical element; a first holding member that holds the optical element; and a second holding member that holds the first holding member via a plurality of connections, and has a linear expansion coefficient different from that of each one of the optical element and the first holding member. When the plurality of connections are displaced upon receiving a force depending on the difference of the linear expansion coefficients between the first holding member and the second holding member, the first holding member causes the connection to the optical element to be displaced in a predetermined direction different from the displacement. The predetermined direction is the opposite direction of a force received by the connection between the optical element and the first holding member, depending on the difference of the linear expansion coefficients between the optical element and the second holding member.

### BACKGROUND OF THE INVENTION

1. Field of the Invention

The present invention relates to an optical device, an exposure apparatus using the same, and a device manufacturing method.

2. Description of the Related Art

The characteristics of a material and the shape of an optical element to be employed by an exposure apparatus or the like for use in manufacturing of a semiconductor device and a liquid crystal panel is determined on the basis of the required performance. The optical element denoted herein refers to a lens and a mirror that are made of, for example, quartz, glass, low thermal expansion material, and the like. The lens is intended to transmit light flux, whereas the mirror is intended to reflect light flux. Also, exemplary characteristics of the optical element include surface shape, transmitted wavefront aberration, transmittance, birefringence, and the like.

Conventionally, as a holding device (optical device) for such an optical element, there has been proposed a holding device in which the material and the dimension of its components are appropriately determined so as to reduce the effect of the thermal expansion and thermal shrinkage of the components on optical performance when the temperature of the optical device changes. The lens holding mechanism disclosed in Japanese Patent Laid-Open No. 2005-215503 determines the optical element, i.e., lens and the holding members of the lens by their thermal expansion coefficients and dimension under certain conditions. With this lens holding mechanism, the generation of a force that tightens the lens in the radial direction or the occurrence of rattling between the lens and the holding members are prevented under a wider range of temperature environment, whereby optical performance is favorably maintained. Also, the optical element holding device disclosed in WO2008/146655 is provided with a direction converting mechanism in which a cushioning member having greater linear expansion coefficient than that of a frame body is mounted on the frame body for holding an optical element such that a supporting member formed on the frame body moves inward along a radial direction due to the elongation of the cushioning member.

However, in the lens holding mechanism disclosed in Japanese Patent Laid-Open No. 2005-215503, the radial dimension of the holding members is determined only from the viewpoint of temperature environmental resistance, whereby the radial dimension cannot be determined from the viewpoint of space saving. Therefore, the conventional optical device has a relatively large external dimension, resulting in an increase in weight and dimension of the product. For example, let it be assumed that the lens holding mechanism disclosed in Japanese Patent Laid-Open No. 2005-215503 is applied to the optical system of a semiconductor exposure apparatus. In this case, the material of the lens is synthetic-quartz, and its radius A is 100 mm. Also, a lens holding frame and holding members have ultraviolet resistance properties, and aluminum alloy and steel are respectively selected as readily available materials at a relatively low cost. Here, the linear expansion coefficients of synthetic-quartz, aluminum alloy, and steel are assumed to be, respectively, 0.5 ppm/° C., 23 ppm/° C., and 12 ppm/° C., then B=105 mm, and C=205 mm. Specifically, the outer diameter of the lens holding frame is more than twice the outer diameter of the lens. Furthermore, the weight and the floor area of an exposure apparatus having such an optical device becomes large, and the manufacturing cost for a device employing the exposure apparatus undesirably increases.

In contrast, the optical element holding device disclosed in WO2008/146655 becomes structurally complicated, and thus the manufacturing cost still increases even if a size reduction thereof is realized. Consequently, it is difficult to reduce the manufacturing cost for an exposure apparatus and a device employing the exposure apparatus.

### SUMMARY OF THE INVENTION

The present invention has been developed in consideration of the circumstances described above, and provides a compact optical device that can favorably maintain focusing performance under a wider range of temperature environments.

According to an aspect of the present invention, an optical device is provided that includes an optical element; a first holding member that holds the optical element; and a second holding member that holds the first holding member via a plurality of connections, and has a linear expansion coefficient different from that of each one of the optical elements and the first holding member, wherein, when the plurality of connections is displaced upon receiving a force depending on the difference in the linear expansion coefficients between the first holding member and the second holding member, the first holding member causes the connection to the optical element to be displaced in a predetermined direction different from the displacement, and wherein the predetermined direction is the opposite direction of the force received by the connection between the optical element and the first holding member, depending on the difference in the linear expansion coefficients between the optical element and the second holding member.

Furthermore, according to another aspect of the present invention, an optical device is provided that includes an optical element; a first holding member that holds the optical element via a plurality of connections, and has a linear expansion coefficient different from that of the optical element; and a second holding member that holds the first holding member and has a linear expansion coefficient different from that of the optical element, wherein, when the plurality of connections is displaced upon receiving a force depending on the difference of the linear expansion coefficients between the optical element and the first holding member, the first holding member causes the plurality of connections to be displaced in a predetermined direction different from the displacement, and wherein the predetermined direction is the opposite direction of the force received by the plurality of connections, depending on the difference in the linear expansion coefficients between the optical element and the second holding member.

According to the present invention, there is provided a compact optical device that can favorably maintain focusing performance under a wider range of temperature environments since a predetermined component is displaced in a predetermined direction that is different from the displacement direction of the first holding member depending on the difference in the linear expansion coefficients between components.

Further features of the present invention will become apparent from the following description of exemplary embodiments with reference to the attached drawings.

### BRIEF DESCRIPTION OF THE DRAWINGS

FIG. 1A is a plan view illustrating an optical device according to a first embodiment of the present invention.

FIG. 1B is a plan view illustrating the particulars of a link mechanism shown in FIG. 1A.

FIG. 2 is a plan view illustrating an optical device according to a second embodiment of the present invention.

FIG. 3 is a plan view illustrating another example of an optical device according to a second embodiment of the present invention.

FIG. 4A is a plan view illustrating an optical device according to a third embodiment of the present invention.

FIG. 4B is a plan view illustrating the particulars of a link mechanism shown in FIG. 4A.

FIG. 5A is a plan view illustrating an optical device according to a sixth embodiment of the present invention.

FIG. 5B is a plan view illustrating the particulars of a link mechanism shown in FIG. 5A.

FIG. 6A is a plan view illustrating an optical device according to a seventh embodiment of the present invention.

FIG. 6B is a plan view illustrating the particulars of a link mechanism shown in FIG. 6A.

FIG. 7 is a schematic diagram illustrating an exposure apparatus to which the optical device of the present invention is applied.

FIG. 8A is a plan view illustrating the shape of a link mechanism according to another embodiment of the present invention.

FIG. 8B is a plan view illustrating the shape of a link mechanism according to another embodiment of the present invention.

FIG. 9 is a plan view illustrating an optical device according to another embodiment of the present invention.

### DESCRIPTION OF THE EMBODIMENTS

Hereinafter, preferred embodiments of the present invention will now be described with reference to the accompanying drawings.

### First Embodiment

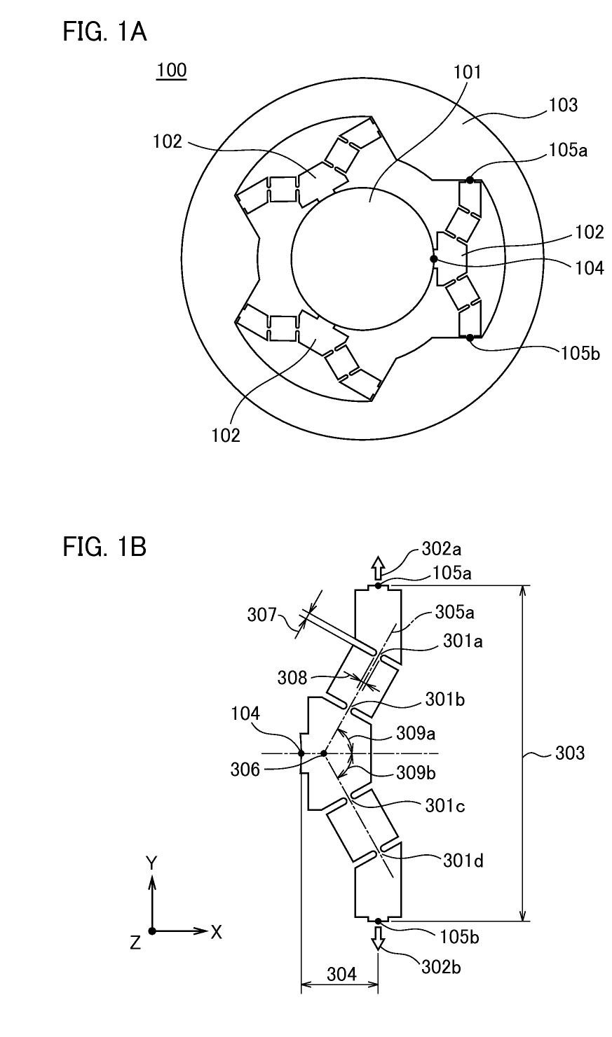

First, an optical device according to a first embodiment of the present invention will now be described. Each of FIGS. 1A and 1B is a schematic diagram illustrating the configuration of an optical device according to the first embodiment. More specifically, FIG. 1A is a plan view of an optical device, and FIG. 1B is a plan view illustrating the detail of the link mechanism shown in FIG. 1A. Hereinafter, the optical device of the present invention is intended to be a holding device that holds a lens, i.e., an optical element, and be mounted on an apparatus (e.g., exposure apparatus) that utilizes the lens. An optical device 100 includes a lens 101, a link mechanism 102 that holds the lens 101, and a barrel 103 that supports the link mechanism 102. In the present embodiment, the lens 101 is a disk-shaped optical element, and the material of the lens 101 is a synthetic-quartz (linear expansion coefficient=about 0.5 ppm/° C.).

The link mechanism 102 is a first holding member, and the three first holding members are provided within the barrel 103 such that the peripheral portion of the lens 101 is evenly held at three locations. In the present embodiment, the material of the link mechanism 102 is an aluminum alloy (linear expansion coefficient=about 23 ppm/° C.). The connection between one of the link mechanisms 102 and the lens 101 is made via the contact with a single lens connection (first connection) 104. Likewise, the connection between one of the link mechanisms 102 and the barrel 103 is made via the contact with two barrel connections (second connection) 105a and 105b. At this time, the barrel connections 105a and 105b are disposed on either side with respect to a line extending between the center of the lens 101 and the lens connection 104. The connection between each of the barrel connections 105a and 105b and the barrel 103 may be simply made by mating them or may be fixed via a connection member such as a screw or the like, and is not particularly limited.

As shown in FIG. 1B, the link mechanism 102 is an integrally-formed direction converting mechanism having five (a plurality of) members that are connected via four elastic hinges 301a to 301d, respectively. The link mechanism 102 is deformed by forces 302a and 302b that are applied to the barrel connections 105a and 105b, respectively. When a dimension 303 between the barrel connections changes, the dimension 304 in the radial direction also changes in association therewith. For example, when the dimension 303 between the barrel connections is increased, the lens connection 104 moves relatively outward along the radial direction of the lens 101.

Each of the elastic hinges 301a to 301d is a portion that readily undergoes bending deformation with respect to the moment of force about the axis in the Z direction shown in FIG. 1B, and serves as a hinge. Here, as described above, the requirement under which the relative displacement direction of the lens connection 104 is directed outward along the radial direction of the lens 101 is as follows. Specifically, an intersection 306 of a straight line 305a passing through elastic hinges 301a and 301b with a straight line 305b passing through elastic hinges 301c and 301d is positioned inward, along the radial direction of the lens 101, from each of the elastic hinges 301a to 301d. It is desirable that each of the elastic hinges 301a to 301d has low rigidity in the rotational direction and high rigidity in the translational direction. For example, it is desirable that a length dimension 307 of the elastic hinge and a width dimension 308 thereof be set as small as possible. In order to realize this arrangement, the elastic hinges 301a to 301d may be molded by wire cut processing. In addition, the elastic hinges 301a to 301d are integrally formed, whereby the elastic hinges 301a to 301d are prevented from rattling. Therefore, in the present embodiment, the occurrence of a positional shift of the lens 101 due to external impact can be prevented by employing the elastic hinge described above.

The barrel 103 is a second holding member that supports the lens 101 via three link mechanisms 102. In the present embodiment, the material of the barrel 103 is steel (linear expansion coefficient=about 12 ppm/° C.). In the present embodiment, for convenience of description, the second holding member is referred to as a “barrel”, the practical barrel that holds a portion corresponding to the barrel 103 from the outside may also be provided.

Next, a description will now be given of the principle upon which the force applied to the lens 101 due to thermal expansion and thermal shrinkage of each component, i.e., the force pushing/pulling the lens 101 in the radial direction due to the link mechanism 102, is reduced when the temperature of the entire system of the optical device 100 changes. Here, the linear expansion coefficients of the lens 101, the link mechanism 102, and the barrel 103 of the present embodiment satisfy the following two conditions. Specifically, the linear expansion coefficient of the lens 101 is less than the linear expansion coefficient of the barrel 103, and the linear expansion coefficient of the link mechanism 102 is greater than the linear expansion coefficient of the barrel 103.

First, a description will be made of the case where the temperature of the entire system of the optical device 100 rises. When the temperature of the entire system rises, thermal expansion occurs in the components of the entire system. At this time, the force pulling the lens 101 outward along the radial direction occurs as shown in the following “phenomenon 1”, and at the same time, the force pushing the lens 101 inward along the radial direction occurs as shown in the following “phenomenon 2”, whereby at least a part of the force that occurs in the phenomenon 1 is cancelled out. Therefore, in this case, the force applied to the lens 101 due to thermal expansion of the components of the entire system, i.e., the force pushing/pulling the lens 101 in the radial direction due to the link mechanism 102 is reduced.

Here, the term “phenomenon 1” as used herein refers to a phenomenon in which the barrel 103 expands relative to the lens 101 because the linear expansion coefficient of the barrel 103 is greater than the linear expansion coefficient of the lens 101, and the lens 101 is thereby pulled outward along the radial direction via the link mechanism 102. On the other hand, since the linear expansion coefficient of the barrel 103 is less than the linear expansion coefficient of the link mechanism 102, the barrel 103 shrinks relative to the link mechanism 102. Specifically, the term “phenomenon 2” as used herein refers to a phenomenon in which the barrel 103 applies a force to the barrel connections 105a and 105b of the link mechanism 102 in a direction in which they become close to each other, and the link mechanism 102 serves as a direction converting mechanism to thereby push the lens 101 inward along the radial direction. In this manner, when the two barrel connections 105a and 105b are displaced by receiving forces depending on the difference in linear expansion coefficients between the link mechanism 102 and the barrel 103, the link mechanism 102 causes the lens connection 104 to be displaced in a predetermined direction that is different from the displacement. Here, the term “predetermined direction” as used herein refers to a direction opposite to the force received by the lens connection 104 depending on the difference in the linear expansion coefficients between the lens 101 and the barrel 103, i.e., a direction directed inward along the radial direction of the lens 101.

On the other hand, likewise, when the temperature of the entire system of the optical device 100 drops, the force applied to the lens 101 due to thermal shrinkage of each component, i.e., the force pushing/pulling the lens 101 in the radial direction due to the link mechanism 102, is reduced.

Next, the conversion magnification of the link mechanism 102 will now be described. Here, the term “conversion magnification” as used herein refers to an amount of change in a radial dimension 304 with respect to an amount of change in the dimension 303 between the barrel connections when the link mechanism 102 serves as the direction converting mechanism. In FIG. 1B, the conversion magnification can be changed by changing the design of the inclination angles 309a and 309b between the straight lines 305a and 305b with respect to the radial direction of the lens 101. More specifically, the conversion magnification becomes small when the inclination angles 309a and 309b become small, whereas the conversion magnification becomes large when the inclination angles 309a and 309b become large. In other words, when the conversion magnification becomes large, the force generated by the phenomenon 2 becomes large, whereby a major part of the force generated by the phenomenon 1 may be cancelled out, and the focusing performance of the optical system may be favorably maintained under a wider range of temperature environment. However, at the same time, the spring constant of the link mechanism 102 in the radial direction of the lens 101 is reduced, whereby the vibration of the lens 101 readily occurs in response to background vibration, resulting in undesirable degradation of focusing performance of the optical system. Likewise, when the conversion magnification is reduced, the reverse of the above-noted advantages and disadvantages occurs. Hence, it is desirable that the conversion magnification be determined to ensure the best focusing performance.

As described above, according to the optical device of the present embodiment, even when the temperature of the entire system of the optical device 100 changes, the force to be applied to the lens 101, which is caused by the thermal expansion and thermal shrinkage of the components, can be efficiently reduced. Therefore, the optical device 100 can favorably maintain its focusing performance under a wider range of temperature environments. In addition, since the radial dimension of the link mechanism 102 and the barrel 103 is not determined only from the viewpoint of ambient temperature tolerance, space saving is realized. Consequently, the size of the optical device 100 can be made compact.

### Second Embodiment

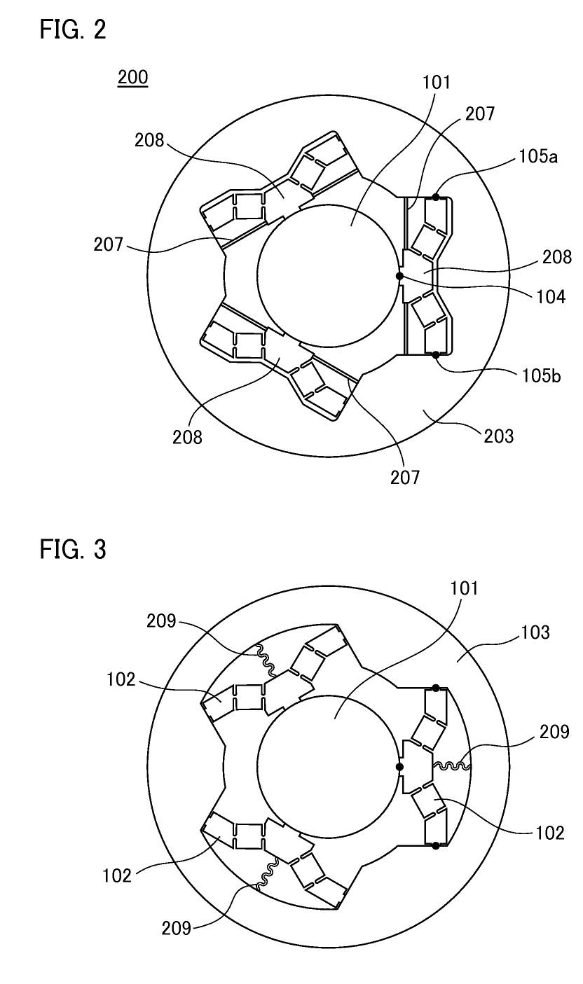

Next, an optical device according to a second embodiment of the present invention will now be described. FIG. 2 is a schematic diagram illustrating the configuration of an optical device 200 according to the second embodiment. In FIG. 2, the same elements as those shown in FIG. 1 are designated by the same reference numerals and explanation thereof will be omitted. Here, in order to efficiently cancel out a portion of the force applied to the lens 101 upon temperature change, as in the first embodiment, it is desirable that the temperature difference among the lens 101, the link mechanism 102, and the barrel 103 be made as small as possible. Accordingly, the optical device 200 is characterized in that the link mechanism 102 is connected with a barrel 203 via a heat pipe 207 at different locations of the barrel connections 105a and 105b in order to keep the temperature difference between the link mechanism 102 and the barrel 203 small.

The heat pipe 207 is a rod-like member made of metal material exhibiting excellent thermal conductivity. The heat pipe 207 is arranged such that its longitudinal direction is parallel to the tangent at the lens connection 104, i.e., its spring constant in the radial direction of the lens 101 decreases as the member for connecting the link mechanism 102 with the barrel 203. With this arrangement, even in the case of the occurrence of the phenomenon 2, the heat pipe 207 can prevent the force pushing the lens 101 inward along the radial direction of the lens 101 by the link mechanism 102 from being excessively disturbed. Therefore, the heat pipe 207 can prevent the function of the optical device that can favorably maintain focusing performance under a wider range of temperature environment from being impaired.

As an additional member for connecting the link mechanism 102 with the barrel 203 so as to enhance thermal conductivity therebetween, a heat pipe 209 subjected to bend processing so as to reduce the spring constant in the radial direction of the lens 101 may also be employed, as shown in FIG. 3. A metal foil such as copper exhibiting excellent thermal conductivity and flexibility may also be employed. In other words, it is requisite that a member material for enhancing thermal conductivity has a sufficiently small spring constant in the radial direction of the lens 101, and has high thermal conductivity.

Next, the operation of the heat pipe 207 will now be described. When the lens 101 partially absorbs exposure light and thereby the temperature of the lens 101 increases, heat is transmitted from the lens 101 to the link mechanism 102, further transmitted from the link mechanism 102 to the barrel 203, and finally released from the barrel 203 to the exterior of the optical device. At this time, the temperature of the link mechanism 102 is higher than that of the barrel 203. However, thermal conduction from the link mechanism 102 to the barrel 203 is increased by the provision of the heat pipe 207, whereby the temperature difference between the link mechanism 102 and the barrel 203 can be small.

As described above, according to the optical device 200 of the present embodiment, the temperature difference between the link mechanism 102 and the barrel 203 can be kept small, whereby the same operation and effect as those of the optical device 100 according to the first embodiment are attained more efficiently. In the optical device 200, the shape and the position of the barrel 203 are determined such that a clearance 208 between the link mechanism 102 and the barrel 203 is made as small as possible. With this arrangement, thermal conductivity is increased by the heat conduction path of atmosphere that is present in the clearance 208, and the temperature difference between the link mechanism 102 and the barrel 203 can thereby be further reduced.

### Third Embodiment

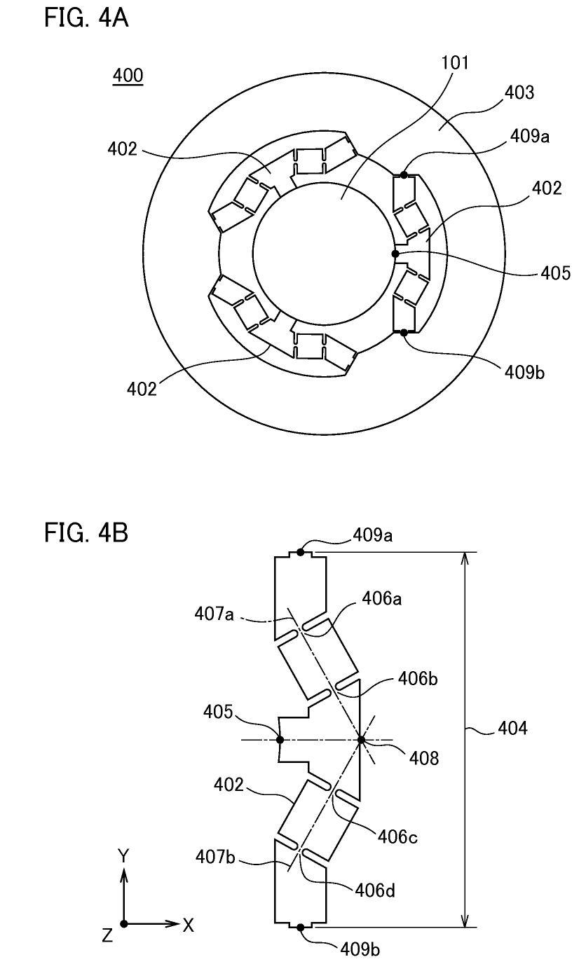

Next, an optical device according to a third embodiment of the present invention will now be described. Each of FIGS. 4A and 4B is a schematic diagram illustrating the configuration of an optical device 400 according to the third embodiment. More specifically, FIG. 4A is a plan view of the optical device 400, and FIG. 4B is a plan view illustrating the detail of the link mechanism shown in FIG. 4A. In FIGS. 4A and 4B, the same elements as those shown in FIGS. 1A and 1B are designated by the same reference numerals and explanation thereof will be omitted. As in the optical device according to the aforementioned embodiments, the optical device 400 includes the lens 101, a link mechanism 402 that holds the lens 101, and a barrel 403 that supports the link mechanism 402.

A feature of the optical device 400 of the present embodiment is that the shape and the material of the link mechanism 402 are different from those of the link mechanism 102 constituting the optical device 100 of the first embodiment. Specifically, the link mechanism 402 has such a shape that the lens connection 405 moves relatively inward along the radial direction of the lens 101 when a dimension 404 between the barrel connections increases. Also, the material of the link mechanism 402 is steel (linear expansion coefficient=about 12 ppm/° C.). In contrast, in the present embodiment, the material of the barrel 403 is aluminum alloy (linear expansion coefficient=about 23 ppm/° C.).

As shown in FIG. 4B, the link mechanism 402 is an integrally-formed direction converting mechanism having five (a plurality of) members that are connected via four elastic hinges 406a to 406d, respectively. Each of the elastic hinges 406a to 406d is a portion that readily undergoes bending deformation with respect to the moment of force about the axis in the Z direction shown in FIG. 4B, and serves as a hinge. Here, the requirement under which the relative movement direction of the lens connection 405 is directed inward along the radial direction of the lens 101 is as follows. Specifically, an intersection 408 of a straight line 407a passing through elastic hinges 406a and 406b with a straight line 407b passing through elastic hinges 406c to 406d is positioned on the outside, in the radial direction of the lens 101, from each of the elastic hinges 406a to 406d.

Next, a description will now be given of the principle upon which the force applied to the lens 101 due to thermal expansion and thermal shrinkage of each component, i.e., the force pushing/pulling the lens 101 in the radial direction due to the link mechanism 402, is reduced when the temperature of the entire system of the optical device 400 changes. Here, the linear expansion coefficients of the lens 101, the link mechanism 402, and the barrel 403 of the present embodiment satisfy the following two conditions. Specifically, the linear expansion coefficient of the lens 101 is less than the linear expansion coefficient of the barrel 403, and the linear expansion coefficient of the link mechanism 402 is less than the linear expansion coefficient of the barrel 403.

First, a description will be made on the case where the temperature of the entire system of the optical device 400 rises. When the temperature of the entire system rises, thermal expansion occurs in the components of the entire system. At this time, the force pulling the lens 101 outward along the radial direction occurs as shown in the following “phenomenon 3”, and at the same time, the force pushing the lens 101 inward along the radial direction occurs as shown in the following “phenomenon 4”, whereby at least a part of the force that occurs in the phenomenon 3 is cancelled out. Therefore, in this case, the force applied to the lens 101 due to thermal expansion of the components of the entire system, i.e., the force pushing/pulling the lens 101 in the radial direction due to the link mechanism 402 is reduced.

Here, the term “phenomenon 3” as used herein refers to a phenomenon in which the barrel 403 expands relative to the lens 101 because the linear expansion coefficient of the barrel 403 is greater than the linear expansion coefficient of the lens 101, and the lens 101 is thereby pulled outward along the radial direction via the link mechanism 402. On the other hand, since the linear expansion coefficient of the barrel 403 is greater than the linear expansion coefficient of the link mechanism 402, the barrel 403 expands relative to the link mechanism 402. Specifically, the term “phenomenon 4” as used herein refers to a phenomenon in which the barrel 403 applies a force to the barrel connections 409a and 409b of the link mechanism 402 in a direction in which they become away from each other, and the link mechanism 402 serves as a direction converting mechanism to thereby push the lens 101 inward along the radial direction. In this manner, when the two barrel connections 409a and 409b are displaced by receiving forces depending on the difference in linear expansion coefficients between the link mechanism 402 and the barrel 403, the link mechanism 402 causes the lens connection 405 to be displaced in a predetermined direction that is different from the displacement. Here, the term “predetermined direction” as used herein refers to a direction opposite to the force received by the lens connection 405 depending on the difference in the linear expansion coefficients between the lens 101 and the barrel 403, i.e., a direction directed inward along the radial direction of the lens 101.

On the other hand, likewise, when the temperature of the entire system of the optical device 400 drops, the force applied to the lens 101 due to thermal shrinkage of each component, i.e., the force pushing/pulling the lens 101 in the radial direction due to the link mechanism 402, is reduced.

As described above, according to the optical device of the present embodiment, the same operation and effect as those of the optical device 100 according to the first embodiment are attained.

### Fourth Embodiment

Next, an optical device according to a fourth embodiment of the present invention will now be described. A feature of the optical device of the present embodiment is that the configuration and shape of the optical device are the same as those of the optical device 100 according to the first embodiment except that the material of the components of the optical device is different from the material of those of the optical device 100 of the first embodiment. Specifically, in the optical device of the present embodiment, the material of the lens 101 is fluorite (linear expansion coefficient=about 19 ppm/° C.). In contrast, the material of the link mechanism 102 is steel (linear expansion coefficient=about 12 ppm/° C.), and the material of the barrel 103 is austenitic stainless steel SUS 304 (linear expansion coefficient=about 17 ppm/° C.). In the following description, for convenience of description, the reference numeral of each component is assumed to be the same as that of the optical device 100 according to the first embodiment.

Next, a description will now be given of the principle upon which the force applied to the lens 101 due to thermal expansion and thermal shrinkage of each component, i.e., the force pushing/pulling the lens 101 in the radial direction due to the link mechanism 102, is reduced when the temperature of the entire system of the optical device changes. Here, the linear expansion coefficients of the lens 101, the link mechanism 102, and the barrel 103 of the present embodiment satisfy the following two conditions. Specifically, the linear expansion coefficient of the lens 101 is greater than the linear expansion coefficient of the barrel 103, and the linear expansion coefficient of the link mechanism 102 is less than the linear expansion coefficient of the barrel 103.

First, a description will be made on the case where the temperature of the entire system of the optical device rises. When the temperature of the entire system rises, thermal expansion occurs in the components of the entire system. At this time, the force pushing the lens 101 inward along the radial direction occurs as shown in the following “phenomenon 5”, and at the same time, the force pulling the lens 101 outward along the radial direction occurs as shown in the following “phenomenon 6”, whereby at least a part of the force that occurs in the phenomenon 5 is cancelled out. Therefore, in this case, the force applied to the lens 101 due to thermal expansion of the components of the entire system, i.e., the force pushing/pulling the lens 101 in the radial direction due to the link mechanism 102 is reduced.

Here, the term “phenomenon 5” as used herein refers to a phenomenon in which the barrel 103 shrinks relative to the lens 101 because the linear expansion coefficient of the barrel 103 is less than the linear expansion coefficient of the lens 101, and the lens 101 is thereby pressed inward along the radial direction via the link mechanism 102. On the other hand, since the linear expansion coefficient of the barrel 103 is greater than the linear expansion coefficient of the link mechanism 102, the barrel 103 expands relative to the link mechanism 102. Specifically, the term “phenomenon 6” as used herein refers to a phenomenon in which the barrel 103 applies a force to the barrel connections 105a and 105b of the link mechanism 102 in a direction in which they become away from each other, and the link mechanism 102 serves as a direction converting mechanism to thereby pull the lens 101 outward along the radial direction. In this manner, when the two barrel connections 105a and 105b are displaced by receiving forces depending on the difference in linear expansion coefficients between the link mechanism 102 and the barrel 103, the link mechanism 102 causes the lens connection 104 to be displaced in a predetermined direction that is different from the displacement. Here, the term “predetermined direction” as used herein refers to a direction opposite to the force received by the lens connection 104 depending on the difference in the linear expansion coefficients between the lens 101 and the barrel 103, i.e., a direction directed outward along the radial direction of the lens 101.

On the other hand, likewise, when the temperature of the entire system of the optical device drops, the force applied to the lens 101 due to thermal shrinkage of each component, i.e., the force pushing/pulling the lens 101 in the radial direction due to the link mechanism 102, is reduced.

As described above, according to the optical device of the present embodiment, the same operation and effect as those of the optical device 100 according to the first embodiment are attained.

### Fifth Embodiment

Next, an optical device according to a fifth embodiment of the present invention will now be described. A feature of the optical device of the present embodiment is that the configuration and shape of the optical device are the same as those of the optical device 400 according to the third embodiment except that the material of the components of the optical device is different from the material of those of the optical device 400 of the third embodiment. Specifically, in the optical device of the present embodiment, the material of the lens 101 is fluorite (linear expansion coefficient=about 19 ppm/° C.). In contrast, the material of the link mechanism 402 is aluminum alloy (linear expansion coefficient=about 23 ppm/° C.), and the material of the barrel 403 is steel (linear expansion coefficient=about 12 ppm/° C.). In the following description, for convenience of description, the reference numeral of each component is assumed to be the same as that of the optical device 400 according to the third embodiment.

Next, a description will now be given of the principle upon which the force applied to the lens 101 due to thermal expansion and thermal shrinkage of each component, i.e., the force pushing/pulling the lens 101 in the radial direction due to the link mechanism 402, is reduced when the temperature of the entire system of the optical device changes. Here, the linear expansion coefficients of the lens 101, the link mechanism 402, and the barrel 403 of the present embodiment satisfy the following two conditions. Specifically, the linear expansion coefficient of the lens 101 is greater than the linear expansion coefficient of the barrel 103, and the linear expansion coefficient of the link mechanism 402 is greater than the linear expansion coefficient of the barrel 403.

First, a description will be made on the case where the temperature of the entire system of the optical device rises. When the temperature of the entire system rises, thermal expansion occurs in the components of the entire system. At this time, the force pushing the lens 101 inward along the radial direction occurs as shown in the following “phenomenon 7”, and at the same time, the force pulling the lens 101 outward along the radial direction occurs as shown in the following “phenomenon 8”, whereby at least a part of the force that occurs in the phenomenon 5 is cancelled out. Therefore, in this case, the force applied to the lens 101 due to thermal expansion of the components of the entire system, i.e., the force pushing/pulling the lens 101 in the radial direction due to the link mechanism 402, is reduced.

Here, the term “phenomenon 7” as used herein refers to a phenomenon in which the barrel 403 shrinks relative to the lens 101 because the linear expansion coefficient of the barrel 403 is less than the linear expansion coefficient of the lens 101, and the lens 101 is thereby pressed inward along the radial direction via the link mechanism 402. On the other hand, since the linear expansion coefficient of the barrel 403 is less than the linear expansion coefficient of the link mechanism 102, the barrel 403 shrinks relative to the link mechanism 402. Specifically, the term “phenomenon 8” as used herein refers to a phenomenon in which the barrel 403 applies a force to the barrel connections 409a and 409b of the link mechanism 402 in a direction in which they become close to each other, and the link mechanism 402 serves as a direction converting mechanism to thereby pull the lens 101 outward along the radial direction. In this manner, when the two barrel connections 409a and 409b are displaced by receiving forces depending on the difference in linear expansion coefficients between the link mechanism 402 and the barrel 403, the link mechanism 402 causes the lens connection 405 to be displaced in a predetermined direction that is different from the displacement. Here, the term “predetermined direction” as used herein refers to a direction opposite to the force received by the lens connection 405 depending on the difference in the linear expansion coefficients between the lens 101 and the barrel 403, i.e., a direction directed outward along the radial direction of the lens 101.

On the other hand, likewise, when the temperature of the entire system of the optical device drops, the force applied to the lens 101 due to thermal shrinkage of each component, i.e., the force pushing/pulling the lens 101 in the radial direction due to the link mechanism 402, is reduced.

As described above, according to the optical device of the present embodiment, the same operation and effect as those of the optical device 100 according to the first embodiment are attained.

### Sixth Embodiment

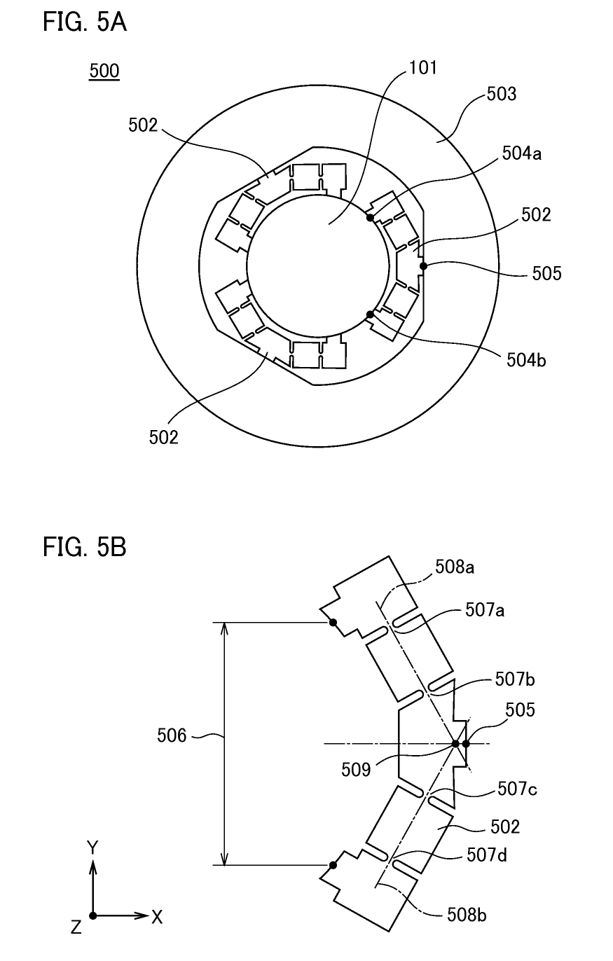

Next, an optical device according to a sixth embodiment of the present invention will now be described. Each of FIGS. 5A and 5B is a schematic diagram illustrating the configuration of an optical device 500 according to the sixth embodiment. More specifically, FIG. 5A is a plan view of the optical device 500, and FIG. 5B is a plan view illustrating the detail of the link mechanism shown in FIG. 5A. In FIGS. 5A and 5B, the same elements as those shown in FIGS. 1A and 1B are designated by the same reference numerals and explanation thereof will be omitted. As in the optical device according to the aforementioned embodiments, the optical device 500 includes the lens 101, a link mechanism 502 that holds the lens 101, and a barrel 503 that supports the link mechanism 502.

A feature of the optical device 500 of the present embodiment is that the shape of the link mechanism 502 is different from that of the link mechanism 102 constituting the optical device 100 of the first embodiment. Specifically, the link mechanism 502 has such a shape that the link mechanism 502 is in contact with the lens 101 via two lens connections 504a and 504b, and is in contact with the barrel 503 via a single barrel connection 505. In other words, the lens connections 504a and 504b are disposed on either side with respect to a line extending between the center of the lens 101 and the barrel connection 505. With this arrangement, the link mechanism 502 has such a shape that the lens connections 504a and 504b move outward along the radial direction of the lens 101 relative to the barrel connection 505 when a dimension 506 between the lens connections increases. In the present embodiment, the material of the barrel 503 is aluminum alloy (linear expansion coefficient=about 23 ppm/° C.).

As shown in FIG. 5B, the link mechanism 502 is an integrally-formed direction converting mechanism having five (a plurality of) members that are connected via four elastic hinges 507a to 507d, respectively. Each of the elastic hinges 507a to 507d is a portion that readily undergoes bending deformation with respect to the moment of force about the axis in the Z direction shown in FIG. 5B, and serves as a hinge. Here, the requirement under which the relative movement direction of the lens connections 504a and 504b is directed outward along the radial direction of the lens 101 is as follows. Specifically, an intersection 509 of a straight line 508a passing through elastic hinges 507a and 507b with a straight line 508b passing through elastic hinges 507c and 507d is positioned on the outside, in the radial direction of the lens 101, from each of the elastic hinges 507a to 507d.

Next, a description will now be given of the principle upon which the force applied to the lens 101 due to thermal expansion and thermal shrinkage of each component, i.e., the force pushing/pulling the lens 101 in the radial direction due to the link mechanism 502, is reduced when the temperature of the entire system of the optical device 500 changes. Here, the linear expansion coefficients of the lens 101, the link mechanism 502, and the barrel 503 of the present embodiment satisfy the following two conditions. Specifically, the linear expansion coefficient of the lens 101 is less than the linear expansion coefficient of the barrel 503, and the linear expansion coefficient of the link mechanism 502 is greater than the linear expansion coefficient of the lens 101.

First, a description will be made on the case where the temperature of the entire system of the optical device 500 rises. When the temperature of the entire system rises, thermal expansion occurs in the components of the entire system. At this time, the force pulling the lens 101 outward along the radial direction occurs as shown in the following “phenomenon 9”, and at the same time, the force pushing the lens 101 inward along the radial direction occurs as shown in the following “phenomenon 10”, whereby at least a part of the force that occurs in the phenomenon 9 is cancelled out. Therefore, in this case, the force applied to the lens 101 due to thermal expansion of the components of the entire system, i.e., the force pushing/pulling the lens 101 in the radial direction due to the link mechanism 502, is reduced.

Here, the term “phenomenon 9” as used herein refers to a phenomenon in which the barrel 503 expands relative to the lens 101 because the linear expansion coefficient of the barrel 503 is greater than the linear expansion coefficient of the lens 101, and the lens 101 is thereby pulled outward along the radial direction via the link mechanism 502. On the other hand, since the linear expansion coefficient of the lens 101 is less than the linear expansion coefficient of the link mechanism 502, the lens 101 shrinks relative to the link mechanism 502. Specifically, the term “phenomenon 10” as used herein refers to a phenomenon in which the lens 101 applies a force to the lens connections 504a and 504b of the link mechanism 502 in a direction in which they become close to each other, and the link mechanism 502 serves as a direction converting mechanism to thereby push the lens 101 inward along the radial direction. In this manner, when the two lens connections 504a and 504b are displaced by receiving forces depending on the difference in linear expansion coefficients between the lens 101 and the link mechanism 502, the link mechanism 502 causes the lens connections 504a and 504b to be displaced in a predetermined direction that is different from the displacement. Here, the term “predetermined direction” as used herein refers to a direction opposite to the force received by the lens connections 504a and 504b depending on the difference in the linear expansion coefficients between the lens 101 and the barrel 503, i.e., a direction directed inward along the radial direction of the lens 101.

On the other hand, likewise, when the temperature of the entire system of the optical device 500 drops, the force applied to the lens 101 due to thermal shrinkage of each component, i.e., the force pushing/pulling the lens 101 in the radial direction due to the link mechanism 502, is reduced.

As described above, according to the optical device of the present embodiment, the same operation and effect as those of the optical device 100 according to the first embodiment are attained.

### Seventh Embodiment

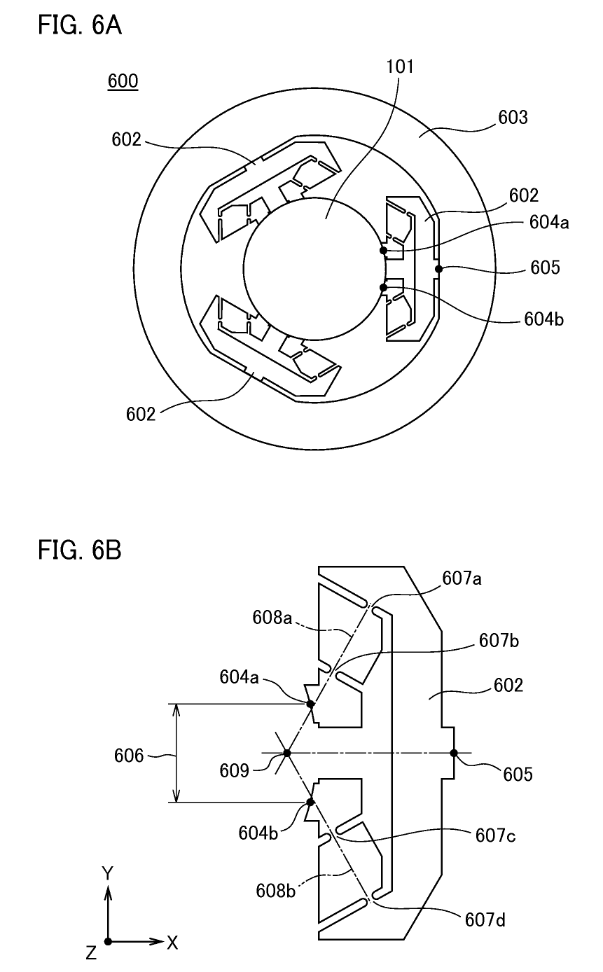

Next, an optical device according to a seventh embodiment of the present invention will now be described. Each of FIGS. 6A and 6B is a schematic diagram illustrating the configuration of an optical device 600 according to the seventh embodiment. More specifically, FIG. 6A is a plan view of the optical device 600, and FIG. 6B is a plan view illustrating the detail of the link mechanism shown in FIG. 6A. In FIGS. 6A and 6B, the same elements as those shown in FIGS. 1A and 1B are designated by the same reference numerals and explanation thereof will be omitted. As in the optical device according to the aforementioned embodiments, the optical device 600 includes the lens 101, a link mechanism 602 that holds the lens 101, and a barrel 603 that supports the link mechanism 602.

A feature of the optical device 600 of the present embodiment is that the link mechanism 602 has a different shape from the link mechanism 502 of the sixth embodiment such that the link mechanism 602 is in contact with the lens 101 via two lens connections 604a and 604b, and is in contact with the barrel 603 via a single barrel connection 605. In this case, the link mechanism 602 has such a shape that the lens connections 604a and 604b move inward along the radial direction of the lens 101 relative to the barrel connection 605 when a dimension 606 between the lens connections increases. In the present embodiment, the material of the lens 101 is fluorite (linear expansion coefficient=about 19 ppm/° C.). In contrast, the material of the link mechanism 602 is steel (linear expansion coefficient=about 12 ppm/° C.), and the material of the barrel 603 is aluminum alloy (linear expansion coefficient=about 23 ppm/° C.).

As shown in FIG. 6B, the link mechanism 602 is an integrally-formed direction converting mechanism having five (a plurality of) members that are connected via four elastic hinges 607a to 607d, respectively. Each of the elastic hinges 607a to 607d is a portion that readily undergoes bending deformation with respect to the moment of force about the axis in the Z direction shown in FIG. 6B, and serves as a hinge. Here, the requirement under which the relative movement direction of the lens connections 604a and 604b is directed inward along the radial direction of the lens 101 is as follows. Specifically, an intersection 609 of a straight line 608a passing through elastic hinges 607a and 607b with a straight line 608b passing through elastic hinges 607c and 607d is positioned on the inside, in the radial direction of the lens 101, from each of the elastic hinges 607a to 607d.

Next, a description will now be given of the principle upon which the force applied to the lens 101 due to thermal expansion and thermal shrinkage of each component, i.e., the force pushing/pulling the lens 101 in the radial direction due to the link mechanism 602, is reduced when the temperature of the entire system of the optical device 600 changes. Here, the linear expansion coefficients of the lens 101, the link mechanism 602, and the barrel 603 of the present embodiment satisfy the following two conditions. Specifically, the linear expansion coefficient of the lens 101 is less than the linear expansion coefficient of the barrel 603, and the linear expansion coefficient of the link mechanism 602 is less than the linear expansion coefficient of the lens 101.

First, a description will be made on the case where the temperature of the entire system of the optical device 600 rises. When the temperature of the entire system rises, thermal expansion occurs in the components of the entire system. At this time, the force pulling the lens 101 outward along the radial direction occurs as shown in the following “phenomenon 11”, and at the same time, the force pushing the lens 101 inward along the radial direction occurs as shown in the following “phenomenon 12”, whereby at least a part of the force that occurs in the phenomenon 11 is cancelled out. Therefore, in this case, the force applied to the lens 101 due to thermal expansion of the components of the entire system, i.e., the force pushing/pulling the lens 101 in the radial direction due to the link mechanism 602, is reduced.

Here, the term “phenomenon 11” as used herein refers to a phenomenon in which the barrel 603 expands relative to the lens 101 because the linear expansion coefficient of the barrel 603 is greater than the linear expansion coefficient of the lens 101, and the lens 101 is thereby pulled outward along the radial direction via the link mechanism 602. On the other hand, since the linear expansion coefficient of the lens 101 is less than the linear expansion coefficient of the link mechanism 602, the lens 101 expands relative to the link mechanism 602. Specifically, the term “phenomenon 12” as used herein refers to a phenomenon in which the lens 101 applies a force to the lens connections 604a and 604b of the link mechanism 602 in a direction in which they become away from each other, and the link mechanism 602 serves as a direction converting mechanism to thereby push the lens 101 inward along the radial direction. In this manner, when the two lens connections 604a and 604b are displaced by receiving forces depending on the difference in linear expansion coefficients between the lens 101 and the link mechanism 602, the link mechanism 602 causes the lens connections 604a and 604b to be displaced in a predetermined direction that is different from the displacement. Here, the term “predetermined direction” as used herein refers to a direction opposite to the force received by the lens connections 604a and 604b depending on the difference in the linear expansion coefficients between the lens 101 and the barrel 603, i.e., a direction directed inward along the radial direction of the lens 101.

On the other hand, likewise, when the temperature of the entire system of the optical device 600 drops, the force applied to the lens 101 due to thermal shrinkage of each component, i.e., the force pushing/pulling the lens 101 in the radial direction due to the link mechanism 602, is reduced.

As described above, according to the optical device of the present embodiment, the same operation and effect as those of the optical device 100 according to the first embodiment are attained.

### Eighth Embodiment

Next, an optical device according to an eighth embodiment of the present invention will now be described. A feature of the optical device of the present embodiment is that the configuration and shape of the optical device are the same as those of the optical device 500 according to the sixth embodiment except that the material of the components of the optical device is different from the material of those of the optical device 500 of the sixth embodiment. Specifically, in the optical device of the present embodiment, the material of the lens 101 is fluorite (linear expansion coefficient=about 19 ppm/° C.). In contrast, the material of the link mechanism 502 and the barrel 503 is steel (linear expansion coefficient=about 12 ppm/° C.). In the following description, for convenience of description, the reference numeral of each component is assumed to be the same as that of the optical device 500 according to the sixth embodiment.

Next, a description will now be given of the principle upon which the force applied to the lens 101 due to thermal expansion and thermal shrinkage of each component, i.e., the force pushing/pulling the lens 101 in the radial direction due to the link mechanism 502, is reduced when the temperature of the entire system of the optical device changes. Here, the linear expansion coefficients of the lens 101, the link mechanism 502, and the barrel 503 of the present embodiment satisfy the following two conditions. Specifically, the linear expansion coefficient of the lens 101 is greater than the linear expansion coefficient of the barrel 503, and the linear expansion coefficient of the link mechanism 502 is less than the linear expansion coefficient of the lens 101.

First, a description will be made on the case where the temperature of the entire system of the optical device rises. When the temperature of the entire system rises, thermal expansion occurs in the components of the entire system. At this time, the force pushing the lens 101 inward along the radial direction occurs as shown in the following “phenomenon 13”, and at the same time, the force pulling the lens 101 outward along the radial direction occurs as shown in the following “phenomenon 14”, whereby at least a part of the force that occurs in the phenomenon 13 is cancelled out. Therefore, in this case, the force applied to the lens 101 due to thermal expansion of the components of the entire system, i.e., the force pushing/pulling the lens 101 in the radial direction due to the link mechanism 502, is reduced.

Here, the term “phenomenon 13” as used herein refers to a phenomenon in which the barrel 503 shrinks relative to the lens 101 because the linear expansion coefficient of the barrel 503 is less than the linear expansion coefficient of the lens 101, and the lens 101 is thereby pushed inward along the radial direction via the link mechanism 502. On the other hand, since the linear expansion coefficient of the lens 101 is greater than the linear expansion coefficient of the link mechanism 502, the lens 101 expands relative to the link mechanism 502. Specifically, the term “phenomenon 14” as used herein refers to a phenomenon in which the lens 101 applies a force to the lens connections 504a and 504b of the link mechanism 502 in a direction in which they become away from each other, and the link mechanism 502 serves as a direction converting mechanism to thereby pull the lens 101 outward along the radial direction. In this manner, when the two lens connections 504a and 504b are displaced by receiving forces depending on the difference in linear expansion coefficients between the lens 101 and the link mechanism 502, the link mechanism 502 causes the lens connections 504a and 504b to be displaced in a predetermined direction that is different from the displacement. Here, the term “predetermined direction” as used herein refers to a direction opposite to the force received by the lens connections 504a and 504b depending on the difference in the linear expansion coefficients between the lens 101 and the barrel 503, i.e., a direction directed outward along the radial direction of the lens 101.

On the other hand, likewise, when the temperature of the entire system of the optical device drops, the force applied to the lens 101 due to thermal shrinkage of each component, i.e., the force pushing/pulling the lens 101 in the radial direction due to the link mechanism 502, is reduced.

As described above, according to the optical device of the present embodiment, the same operation and effect as those of the optical device 100 according to the first embodiment are attained.

### Ninth Embodiment

Next, an optical device according to a ninth embodiment of the present invention will now be described. A feature of the optical device of the present embodiment is that the configuration and shape of the optical device are the same as those of the optical device 600 according to the seventh embodiment except that the material of the components of the optical device is different from the material of those of the optical device 600 of the seventh embodiment. Specifically, in the optical device of the present embodiment, the material of the lens 101 is fluorite (linear expansion coefficient=about 19 ppm/° C.). In contrast, the material of the link mechanism 602 is aluminum alloy (linear expansion coefficient=about 23 ppm/° C.), and the material of the barrel 603 is steel (linear expansion coefficient=about 12 ppm/° C.). In the following description, for convenience of description, the reference numeral of each component is assumed to be the same as that of the optical device 600 according to the seventh embodiment.

Next, a description will now be given of the principle upon which the force applied to the lens 101 due to thermal expansion and thermal shrinkage of each component, i.e., the force pushing/pulling the lens 101 in the radial direction due to the link mechanism 602, is reduced when the temperature of the entire system of the optical device changes. Here, the linear expansion coefficients of the lens 101, the link mechanism 602, and the barrel 603 of the present embodiment satisfy the following two conditions. Specifically, the linear expansion coefficient of the lens 101 is greater than the linear expansion coefficient of the barrel 603, and the linear expansion coefficient of the link mechanism 602 is less than the linear expansion coefficient of the lens 101.

First, a description will be made on the case where the temperature of the entire system of the optical device rises. When the temperature of the entire system rises, thermal expansion occurs in the components of the entire system. At this time, the force pushing the lens 101 inward along the radial direction occurs as shown in the following “phenomenon 15”, and at the same time, the force pulling the lens 101 outward along the radial direction occurs as shown in the following “phenomenon 16”, whereby at least a part of the force that occurs in the phenomenon 15 is cancelled out. Therefore, in this case, the force applied to the lens 101 due to thermal expansion of the components of the entire system, i.e., the force pushing/pulling the lens 101 in the radial direction due to the link mechanism 602, is reduced.

Here, the term “phenomenon 15” as used herein refers to a phenomenon in which the barrel 603 shrinks relative to the lens 101 because the linear expansion coefficient of the barrel 603 is less than the linear expansion coefficient of the lens 101, and the lens 101 is thereby pushed inward along the radial direction via the link mechanism 602. On the other hand, since the linear expansion coefficient of the lens 101 is less than the linear expansion coefficient of the link mechanism 602, the lens 101 shrinks relative to the link mechanism 602. Specifically, the term “phenomenon 16” as used herein refers to a phenomenon in which the lens 101 applies a force to the lens connections 604a and 604b of the link mechanism 602 in a direction in which they become close to each other, and the link mechanism 602 serves as a direction converting mechanism to thereby pull the lens 101 outward along the radial direction. In this manner, when the two lens connections 604a and 604b are displaced by receiving forces depending on the difference in linear expansion coefficients between the lens 101 and the link mechanism 602, the link mechanism 602 causes the lens connections 604a and 604b to be displaced in a predetermined direction that is different from the displacement. Here, the term “predetermined direction” as used herein refers to a direction opposite to the force received by the lens connections 604a and 604b depending on the difference in the linear expansion coefficients between the lens 101 and the barrel 603, i.e., a direction directed outward along the radial direction of the lens 101.

On the other hand, likewise, when the temperature of the entire system of the optical device drops, the force applied to the lens 101 due to thermal shrinkage of each component, i.e., the force pushing/pulling the lens 101 in the radial direction due to the link mechanism 602, is reduced.

As described above, according to the optical device of the present embodiment, the same operation and effect as those of the optical device 100 according to the first embodiment are attained.

### (Exposure Apparatus)

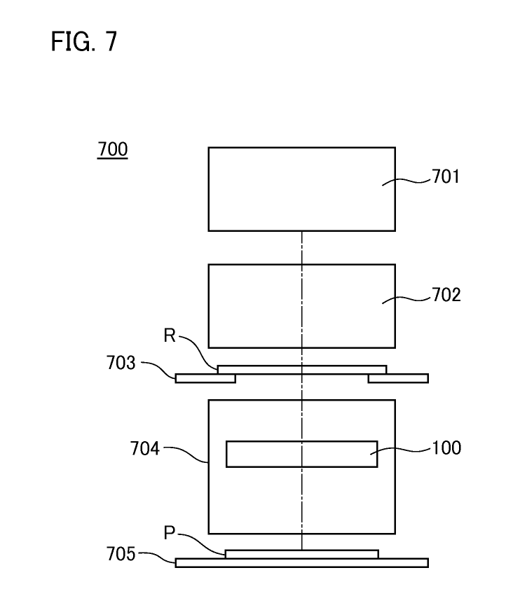

Next, a description will now be given of an embodiment of an exposure apparatus to which the optical device described above is applied. FIG. 7 is a schematic diagram illustrating the configuration of the exposure apparatus of the present invention. An exposure apparatus 700 includes a light source section 701, an illumination optical system 702, an original stage 703, a projection optical system 704, and a substrate stage 705. The illumination optical system 702 includes a plurality of lenses and mirrors, and irradiates light emitted from the light source section 701 onto an original (reticle or mask) R that is held by the original stage 703. The projection optical system 704 has an optical element constituting a plurality of lenses and mirrors, and causes projection light, which has passed through the pattern formed on the original R, to focus on a substrate (substrate to be processed) P held by the substrate stage 705 to thereby conduct exposure processing. The above-noted optical device 100 or the like is applicable to such a mechanism that holds an optical element constituting the illumination optical system 702 or the projection optical system 704. By applying the optical device of the present invention, the exposure apparatus of the present invention can be made such that the aberration of focusing light on the substrate P is favorably reduced under a wider range of temperature environment, and the size of the entire apparatus is made compact.

### (Device Manufacturing Method)

Next, a method of manufacturing a device (semiconductor device, liquid crystal display device, etc.) as an embodiment of the present invention is described. The semiconductor device is manufactured by a front-end process in which an integrated circuit is formed on a wafer, and a back-end process in which an integrated circuit chip is completed as a product from the integrated circuit on the wafer formed in the front-end process. The front-end process includes a step of exposing a wafer coated with a photoresist to light using the above-described exposure apparatus of the present invention, and a step of developing the exposed wafer. The back-end process includes an assembly step (dicing and bonding), and a packaging step (sealing). The liquid crystal display device is manufactured by a process in which transparent electrodes are formed. The process of forming a plurality of transparent electrodes includes a step of coating a glass substrate with a transparent conductive film deposited thereon with a photoresist, a step of exposing the glass substrate coated with the photoresist to light using the above-described exposure apparatus, and a step of developing the exposed glass substrate. The device manufacturing method of this embodiment has an advantage, as compared with a conventional device manufacturing method, in at least one of performance, quality, productivity and production cost of a device.

### Other Embodiments

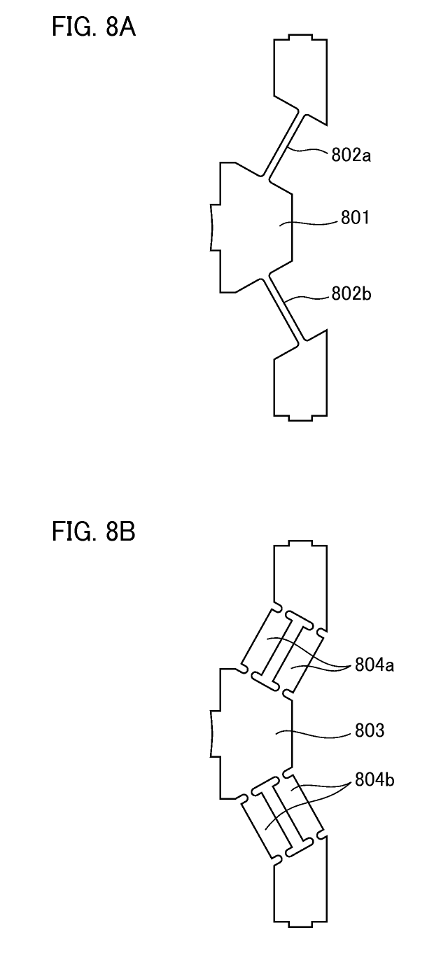

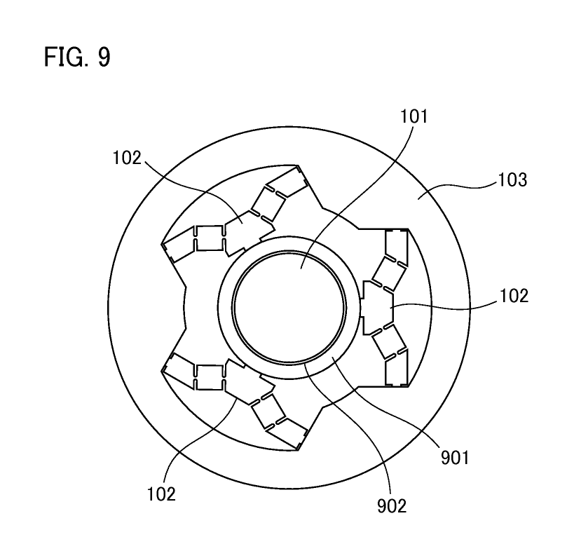

While in the aforementioned embodiments of the optical device, the link mechanism has four elastic hinges, the present invention should not be limited thereto. For example, as shown in FIG. 8A, a link mechanism 801 having two plate spring sections 802a and 802b may also be employed. In this case, the plate spring sections 802a and 802b may be processed not by wire-cutting but by cutting, and thus the cost of the members can be reduced. Likewise, for example, as shown in FIG. 8B, a link mechanism 803 provided with parallel link sections 804a and 804b both having eight elastic hinges may also be employed. Compared to the link mechanism 102 of the first embodiment, the link mechanism employing the parallel link sections 804a and 804b has a high rigidity around the axis in the tangent direction of the lens 101. Therefore, when the lens 101 is installed during assembly of the optical device, the occurrence of the phenomenon in which the link mechanism 102 is twisted by the weight of the lens 101 and thus the position in the optical axis direction of the lens 101 is away from a desired position can be prevented.

Also, while in the aforementioned embodiments of the optical device, each link mechanism directly holds the lens 101, the present invention should not be limited thereto. Specifically, when taking the optical device 100 of the first embodiment as an example, as shown in FIG. 9, the configuration in which the lens 101 is held by a circular ring member 901 and the circular ring member 901 is held by the link mechanism 102 may also be employed. Here, the circular ring member 901 holds the lens 101 by an adhesive 902 that is filled into a gap provided between the circular ring member 901 and the lens 101 along the entire circumference. With this arrangement, a high lens holding performance can be achieved. However, in order to suppress the phenomenon in which the circular ring member 901 subjected to thermal expansion or thermal shrinkage applies a force to the lens 101 upon temperature change, it is desirable that the material of the circular ring member 901 be selected to approximate the linear expansion coefficient between the lens 101 and the circular ring member 901 as closely as possible. Likewise, it is also desirable that the material of the adhesive 902 be selected to approximate the linear expansion coefficient between the lens 101 and the adhesive 902 as closely as possible. However, in general, the rigidity of the adhesive is often sufficiently lower than that of the lens, and thus, it is substantially allowable that the linear expansion coefficient of the lens 101 is different from that of the adhesive 902.

Furthermore, while in the aforementioned embodiments of the optical device, the link mechanisms are provided at three locations, the present invention should not be limited thereto. For example, the link mechanisms may be provided at two locations or at four or more locations. In either case, the same effect as that described in the embodiment may be obtained as long as the link mechanism serves as the direction converting mechanism described above.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-245290 filed Oct. 26, 2009 which is hereby incorporated by reference herein it its entirety.

What is claimed is:

1. An optical device comprising:
an optical element;
a first holding member that holds the optical element; and
a second holding member that holds the first holding member via a plurality of connections, and has a linear expansion coefficient different from that of each one of the optical element and the first holding member,
wherein, when the plurality of connections are displaced upon receiving a force depending on the difference of the linear expansion coefficients between the first holding member and the second holding member, the first holding member causes the connection to the optical element to be displaced in a predetermined direction different from the displacement, and
wherein the predetermined direction is the opposite direction of a force received by the connection between the optical element and the first holding member, depending on the difference of the linear expansion coefficients between the optical element and the second holding member.

2. The optical device according to claim 1, wherein the first holding member includes a plurality of members that are connected via an elastic hinge.

3. The optical device according to claim 1, wherein the plurality of connections are disposed on either side with respect to a line extending between the center of the optical element and the connection between the optical element and the first holding member.

4. The optical device according to claim 1, wherein the linear expansion coefficient of the first holding member is greater than the linear expansion coefficient of the second holding member, and the linear expansion coefficient of the optical element is less than the linear expansion coefficient of the second holding member.

5. The optical device according to claim 1, wherein the linear expansion coefficient of the first holding member is less than the linear expansion coefficient of the second holding member, and the linear expansion coefficient of the optical element is less than the linear expansion coefficient of the second holding member.

6. The optical device according to claim 1, wherein the linear expansion coefficient of the first holding member is less than the linear expansion coefficient of the second holding member, and the linear expansion coefficient of the optical element is greater than the linear expansion coefficient of the second holding member.

7. The optical device according to claim 1, wherein the linear expansion coefficient of the first holding member is greater than the linear expansion coefficient of the second holding member, and the linear expansion coefficient of the optical element is greater than the linear expansion coefficient of the second holding member.

8. An optical device comprising:
an optical element;
a first holding member that holds the optical element via a plurality of connections, and has a linear expansion coefficient different from that of the optical element; and
a second holding member that holds the first holding member, has a linear expansion coefficient different from that of the optical element,
wherein, when the plurality of connections are displaced upon receiving a force depending on the difference of the linear expansion coefficients between the optical element and the first holding member, the first holding member causes the plurality of connections to be displaced in a predetermined direction different from the displacement, and
wherein the predetermined direction is the opposite direction of a force received by the plurality of connections, depending on the difference of the linear expansion coefficients between the optical element and the second holding member.

9. The optical device according to claim 8, wherein the first holding member includes a plurality of members that are connected via an elastic hinge.

10. The optical device according to claim 8, wherein the plurality of connections are disposed on either side with respect to a line extending between the center of the optical element and the connection between the first holding member and the second holding member.

11. The optical device according to claim 8, wherein the linear expansion coefficient of the first holding member is greater than the linear expansion coefficient of the optical element, and the linear expansion coefficient of the optical element is less than the linear expansion coefficient of the second holding member.

12. The optical device according to claim 8, wherein the linear expansion coefficient of the first holding member is less than the linear expansion coefficient of the optical element, and the linear expansion coefficient of the optical element is less than the linear expansion coefficient of the second holding member.

13. The optical device according to claim 8, wherein the linear expansion coefficient of the first holding member is less than the linear expansion coefficient of the optical element, and the linear expansion coefficient of the optical element is greater than the linear expansion coefficient of the second holding member.

14. The optical device according to claim 8, wherein the linear expansion coefficient of the first holding member is greater than the linear expansion coefficient of the optical element, and the linear expansion coefficient of the optical element is greater than the linear expansion coefficient of the second holding member.

15. An exposure apparatus comprising:
an illumination optical system that guides light emitted from a light source to an original; and
a projection optical system that guides light reflected from the original to a substrate,
wherein the illumination optical system or the projection optical system includes an optical device comprising:
an optical element;
a first holding member that holds the optical element; and
a second holding member that holds the first holding member via a plurality of connections, and has a linear expansion coefficient different from that of each one of the optical element and the first holding member,
wherein, when the plurality of connections are displaced upon receiving a force depending on the difference of the linear expansion coefficients between the first holding member and the second holding member, the first holding member causes the connection to the optical element to be displaced in a predetermined direction different from the displacement, and
wherein the predetermined direction is the opposite direction of a force received by the connection between the optical element and the first holding member, depending on the difference of the linear expansion coefficients between the optical element and the second holding member.

16. An exposure apparatus comprising:
an illumination optical system that guides light emitted from a light source to an original; and
a projection optical system that guides light reflected from the original to a substrate,
wherein the illumination optical system or the projection optical system includes an optical device comprising:
an optical element;
a first holding member that holds the optical element via a plurality of connections, and has a linear expansion coefficient different from that of the optical element; and
a second holding member that holds the first holding member, has a linear expansion coefficient different from that of the optical element,
wherein, when the plurality of connections are displaced upon receiving a force depending on the difference of the linear expansion coefficients between the optical element and the first holding member, the first holding member causes the plurality of connections to be displaced in a predetermined direction different from the displacement, and
wherein the predetermined direction is the opposite direction of a force received by the plurality of connections, depending on the difference of the linear expansion coefficients between the optical element and the second holding member.

17. A device manufacturing method comprising the steps of:
exposing a substrate using an exposure apparatus; and
developing the exposed substrate,
wherein the exposure apparatus comprises:
an illumination optical system that guides light emitted from a light source to an original; and
a projection optical system that guides light reflected from the original to a substrate,
wherein the illumination optical system or the projection optical system includes an optical device comprising:
an optical element;
a first holding member that holds the optical element; and
a second holding member that holds the first holding member via a plurality of connections, and has a linear expansion coefficient different from that of each one of the optical element and the first holding member,
wherein, when the plurality of connections are displaced upon receiving a force depending on the difference of the linear expansion coefficients between the first holding member and the second holding member, the first holding member causes the connection to the optical element to be displaced in a predetermined direction different from the displacement, and
wherein the predetermined direction is the opposite direction of a force received by the connection between the optical element and the first holding member, depending on the difference of the linear expansion coefficients between the optical element and the second holding member.

18. A device manufacturing method comprising the steps of:
exposing a substrate using an exposure apparatus; and
developing the exposed substrate,
wherein the exposure apparatus comprises:
an illumination optical system that guides light emitted from a light source to an original; and
a projection optical system that guides light reflected from the original to a substrate,
wherein the illumination optical system or the projection optical system includes an optical device comprising:
an optical element;
a first holding member that holds the optical element via a plurality of connections, and has a linear expansion coefficient different from that of the optical element; and
a second holding member that holds the first holding member, has a linear expansion coefficient different from that of the optical element,
wherein, when the plurality of connections are displaced upon receiving a force depending on the difference of the linear expansion coefficients between the optical element and the first holding member, the first holding member causes the plurality of connections to be displaced in a predetermined direction different from the displacement, and
wherein the predetermined direction is the opposite direction of a force received by the plurality of connections, depending on the difference of the linear expansion coefficients between the optical element and the second holding member.
